(19) United States
(12) Patent Application Publication
(10) Pub. No.: US 2009/0055465 A1
(43) Pub. Date: Feb. 26, 2009

(54) Remote Health Monitoring and Control

(75) Inventors: Adam DePue, Redmond, WA (US); Paul Fitzgerald, Woodinville, WA (US); Kundana Palagiri, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/842,966

(22) Filed: Aug. 22, 2007

(51) Int. Cl. G06F 15/16

(52) U.S. Cl. 709/202

(57) ABSTRACT

A health monitoring and control system for computing devices has a monitoring agent operable on a monitored device that detects status items and transmits the status items to a central system. The central system may log the status items, determine if one or more of the items are out of bounds, and alert a remote device. The remote device may be able to establish an interactive connection with the central system, determine status of the monitored device, and issue commands that are transferred to the monitoring agent on the monitored device. The monitoring agent may be able to execute the commands to adjust settings, perform operations, or other actions to address one or more status items.

### BACKGROUND

Health monitoring of computer systems can be an important function of system administrators in detecting problems or potential problems early. When a problem is detected, an administrator may correct the problem by changing settings for a service, executing various applications, performing an update, or various other actions.

When an administrator operates within an enterprise, the administrator may be able to directly access a computer system or device that is having a problem and perform various maintenance activities.

When the monitored system is outside of an enterprise area, such as a laptop computer that is being used while an employee is travelling, an administrator may not be able to monitor or maintain such a system. Further, when the administrator is outside the enterprise area, such as during weekends or while away from direct access to devices on the network, the administrator may be unable to detect and correct a problem before additional problems occur.

### SUMMARY

A health monitoring and control system for computing devices has a monitoring agent operable on a monitored device that detects status items and transmits the status items to a central system. The central system may log the status items, determine if one or more of the items are out of bounds, and alert a remote device. The remote device may be able to establish an interactive connection with the central system, determine status of the monitored device, and issue commands that are transferred to the monitoring agent on the monitored device. The monitoring agent may be able to execute the commands to adjust settings, perform operations, or other actions to address one or more status items.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a system that may be used to monitor a device.

FIG. 2 is a timeline illustration of an embodiment showing a communication sequence for collecting and storing monitored data, requesting status, and transmitting and executing a command on a monitored device.

### DETAILED DESCRIPTION

A remote monitoring and control system uses monitoring agents operable on monitored devices to detect health status items and send the status items to a central system. The monitoring agents may also be able to receive commands from the central system and perform some operations relating to the health of the monitored device.

The central system may enable monitoring agents to periodically connect and transmit status items in a secure manner, as well as store status items in a status database. The central system may be able to connect with a remote device to transmit alerts for identified problems as well as receive commands that may be transferred to the monitored systems.

The remote monitoring and control system may operate inside and outside of a managed domain or other closed network. In many embodiments, the central system may be reachable through the Internet by both the monitored and remote devices. In other embodiments, the central system may be located within a managed domain or other network yet may be reachable through the Internet by monitored and remote devices.

The health aspects of a monitored device may include security items, performance items, or other items. For each of the various items, a monitoring agent may be able to detect a status as well as perform some action that may affect the status. For example, a monitoring agent may detect the last time a backup operation has been performed and may further be able to initiate a backup operation if such a command was transmitted from the central server.

Specific embodiments of the subject matter are used to illustrate specific inventive aspects. The embodiments are by way of example only, and are susceptible to various modifications and alternative forms. The appended claims are intended to cover all modifications, equivalents, and alternatives falling within the spirit and scope of the invention as defined by the claims.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

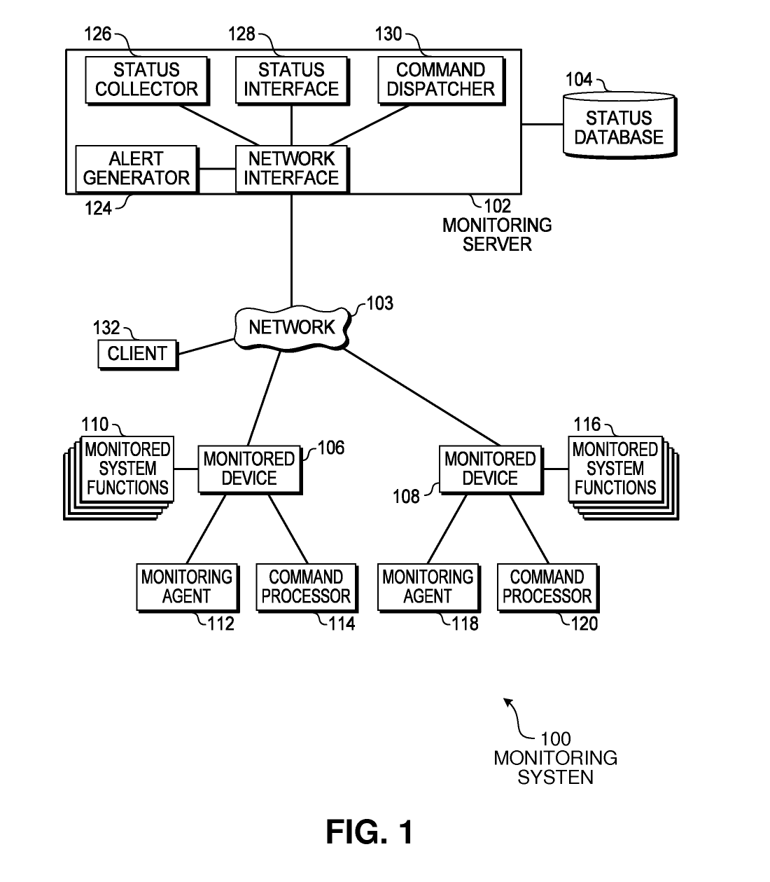

FIG. 1 is a diagram of an embodiment 100 showing a monitoring system. Embodiment 100 illustrates a system that uses a monitoring server 102 to collect data from various monitored devices 106 and 108 and store the data in a status database 104.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the various functions described.

Embodiment 100 enables system functions to be monitored and the data collected and stored on a server. Various client devices may interface with the server to get status information, receive alerts, as well as send commands to the monitored devices regarding the various system functions. The monitored systems may have various mechanisms for receiving and executing the commands.

The entire monitoring system may be used by administrators to monitor various functions of many different devices. The devices may be devices inside or outside a local area network, and the administrator may be able to receive status, alerts, and send commands to address any problems from inside or outside the local area network on which the monitored devices reside.

The monitored devices 106 and 108 may be any type of network enabled device that is capable of being monitored. Such devices may include personal computers such as laptop and desktop computers, server computers, network appliances, network routing and infrastructure devices, mobile devices such as cellular telephones, mobile personal digital assistants, wireless enabled computing devices, or any other network connected device. The monitored devices 106 and 108 may be connected to the network 103 by hardwired connections, such as Ethernet, or may be connected through any type of wireless connection, including cellular telephony, wireless data connections, or any other type of communication mechanism.

Embodiment 100 may be used to monitor devices that are within a local area network as well as devices outside of a local area network. In some embodiments, the monitoring server 102 may connect with the various monitored devices and clients through the Internet or other wide area network. In such embodiments, a firewall or other device in a local area network may enable communication between the monitored devices 106 and 108 and the monitoring server 102.

When the monitoring server 102 is available over the Internet from a monitored device, the device may be monitored even when the device is used outside its normal network. For example, a monitored device may be a laptop computer that a person may use during travel. Because the monitoring system may be active even when the person is using the laptop in an airport or hotel room, the monitoring system can catch potential problems, report improper use or configuration, and correct problems while the person is away from a local area network and their technical support people.

In some embodiments, the monitoring server 102 may be connected to a local area network along with some of the monitored devices. In such an embodiment, a monitored device that is outside the local area network may connect to the monitoring server 102 through a virtual private network or some other mechanism to enable a communication session between the monitored device and the monitoring server 102.

The monitored devices 106 and 108 may include monitoring agents 112 and 118 and command processors 114 and 120 that monitor and send commands to various monitored system functions 110 and 116, respectively. The monitoring server 102 may have various functions such as an alert generator 124, a status collector 126, a status interface 128, and a command dispatcher 130.

The monitoring agents 112 and 118 may communicate with the monitoring server 102 and specifically the status collector 126 in several different manners. In one configuration, the status collector 126 may initiate a communication session with monitoring agent 112 and query the monitoring agent 112 on the monitored device 106. In another configuration, the monitoring agent 118 may determine the status of the various monitored system functions 116, initiate a communication session with the status collector 126, and transmit the status items. The status collector 126 may receive status data and store the data in the status database 104.

In some systems, a presence system may be used to determine that a monitored device 106 is connected to a network and available to the monitoring server 102. A presence system may be a system whereby the monitored device 106 may connect to the network 103 and send presence information to a presence server. Presence information may include a status, such as online, hidden, do not disturb, or other status options. By monitoring a presence server, the monitoring server 102 may be able to detect that a monitored device is connected to a network and may be accessible for monitoring functions. Such presence systems may be used for instant messaging applications as well.

In many embodiments, the monitoring agents 112 and 118 on the monitored devices 106 and 108, respectively, may operate as a background process so that a user of the devices 106 and 108 may not know that the monitoring agents 112 and 118 are functioning. In some such embodiments, the monitoring agents 112 and 118 may be operated as an administrator level function for which a user may or may not have the ability to control.

The monitoring agents 112 and 118 may operate on the monitored devices 106 and 108 without regard to the user that may be logged into the device. For example, a computer system used in a call center may be shared by users from different shifts. Each user may have different login identification; however, the monitoring agents 112 and 118 may be operational on an operating system level so that the monitoring agents operate regardless of the user.

The command processors 114 and 120 may receive commands from a command dispatcher 130 within the monitoring server 102 and perform various functions regarding the monitored system functions 110 and 116. In some cases, the command processors may be adapted to send commands to a system function through an application programming interface for the function. In other cases, the command processors may use scripts within an operating system shell to perform various functions. In some instances, a command processor may be these and other mechanisms for performing actions with various monitored system function.

The monitored system functions 110 and 116 may be any type of function an administrator may wish to monitor and control. In many cases, the monitored system functions 110 and 116 may be selected to enable an administrator to determine a ‘health’ factor for a particular monitored device. Such health status may be presented to the administrator that may use a client 132 to connect to the status interface 128 of the monitoring server 102.

The monitored system functions 110 and 116 may include functions that enable an administrator to determine the device's status. For example, performance monitors of processor, memory, storage, network, and other components of a monitored device may enable an administrator to determine if a device is properly configured for its intended use. Other monitoring functions may include logging of network communications, logging which applications have been run as well as how much processing time each application has consumed, and other similar logging functions. Other monitored functions may include backup functions, operating system update functions, application update functions, and application content monitoring functions.

The monitored system functions 110 and 116 may or may not have a corresponding command by which an administrator may correct or change a setting in response to the monitored status. For example, if a performance monitor indicates that memory usage on a device is unusually high, an administrator may note that the device is a candidate for an upgrade or some other operation. In some case, a monitored system function, such as an anti-virus application, may supply status data and receive commands that are able to change the function or status of the monitored function. In the example of an anti-virus application, a command may be sent from the monitoring server 102 to the monitored device to enable virus checking or to update an out-of-date virus definition.

In some instances, the content of data viewed or processed on a monitored device may be logged. For example, a company may install a monitoring system that logs inappropriate or objectionable Internet content or potentially dangerous communications that may contain trade secret information, national or business security issues, or other content.

Security processes and functions may be part of the monitored system functions 110 and 116. For example, anti-virus, anti-malware, anti-phishing, firewall functions, content filtering functions, application installation functions, encryption functions, network connection functions, and other security related functions may be monitored. In many cases, the security functions may be monitored to determine that the service is functioning, that the settings or policies determined by the administrator have not been changed, that any updates have been performed, that the services have or have not encountered any abnormal situations or potential threats, or other status items.

The alert generator 124 may be configured to detect various abnormalities and send notices to a client device 132. The client device 132 may be any type of communications device adapted to receive email or text information. For example, the client device 132 may be a personal computer, network appliance, personal digital assistant, cellular telephone, or other device with a web browser or email interface. In some instances, the alert generator 124 may be capable of generating and transmitting a voice message to a cellular telephone, pager, or voice mail system.

Alerts may be determined by setting a boundary for certain parameters and generating an alert when a parameter exceeds the boundaries. In other cases, a Boolean logic may be defined for one or more binary conditions to be met in order to determine an alert. In still other cases, complex algorithms may be used to determine when an alert may be sent.

In some cases, alerts may be created that use input from multiple monitored devices. For example, if two or more monitored devices undergo a similar change in status in a short period of time, an alert may be triggered for an administrator to check for a virus or other problem.

Using the interface provided by the status interface 128, a client device 132 may receive the status of one or more monitored devices. In many embodiments, a web interface or monitoring application interface may enable a user to have an interactive session with the monitoring server 102 through a client device 132.

The client device 132 may receive status information through a status interface 128 and send commands through a command dispatcher 130. The status interface may receive requests for queries from a client, perform a query against the status database 104, and return results to the client. The command dispatcher 130 may receive various commands from a client, adapt the commands to the particular monitored device and monitored function, and communicate the command to the appropriate command processor 114 or 120 for execution.

There are many examples of how a system such as embodiment 100 may be used. In a typical scenario, an administrator may configure a device 106 with a monitoring agent 112 and command processor 114. The monitoring agent 112 may be installed and configured to monitor several system functions 110 that may include operational parameters, such as available disk space, processor and memory usage, login time per user, and software licenses that are in use. Additionally, several security functions such as anti-virus, firewall, and default encryption systems may be defined.

After configuring the monitored device 106, the administrator may configure the monitoring server 102 to connect and receive data from the monitored device 106. In some situations, the monitoring server 102 may be provided as a service that is hosted across the Internet. The administrator may configure alerts for the device and specify which system functions 110 are monitored and which commands may be available to the command dispatcher 130.

During normal operation, the monitored device may periodically communicate with the status collector 126 in a background mode to provide updated status information. When a parameter becomes out of bounds or some other condition is met, the alert generator 124 may send a message to an administrator who may connect to the monitoring server 102 with a client device 132. When connected, the administrator may scan various status items and may issue various commands through the command dispatcher 130 to the command processor 114 of the monitored device 106.

The above scenario is merely one usage scenario for the embodiment 100. Other usage scenarios may be created using the functionality described in embodiment 100.

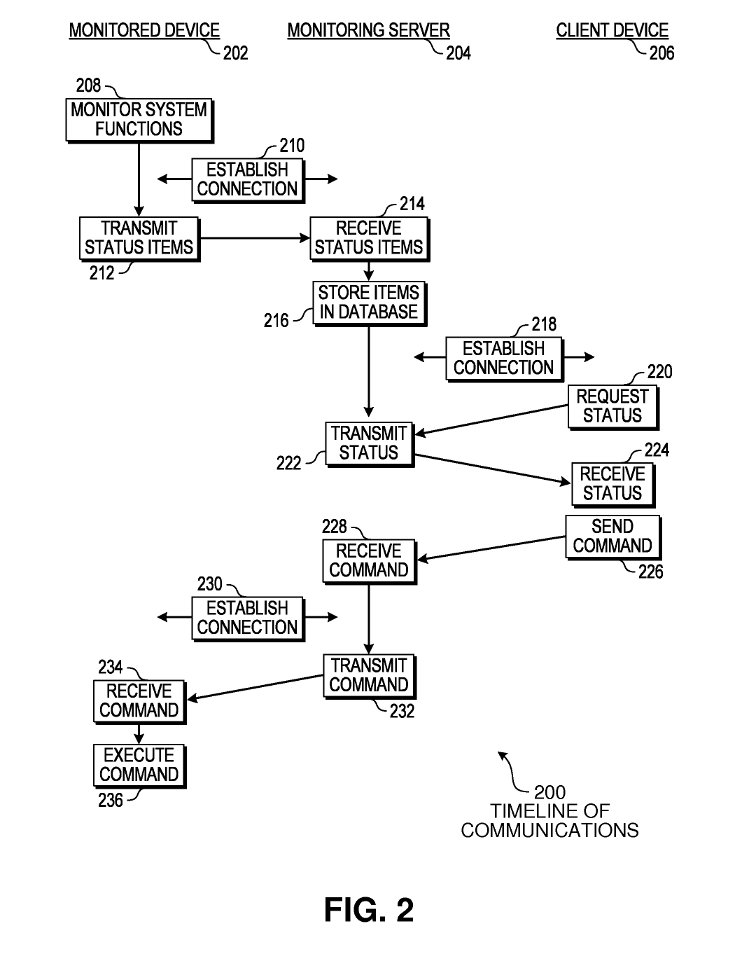

FIG. 2 is a timeline representation of an embodiment 200 showing a possible communication sequence between a monitored device 202 on the left, a monitoring server 204 in the center, and a client device 206 on the right.

Embodiment 200 is an example of the sequence and types of communication that may be performed between the various devices in a monitoring system. Other embodiments may have additional steps or different sequences or handshaking mechanisms.

Embodiment 200 begins after the various devices have been configured and are operational. The monitored device 202 may monitor various system functions in block 208. A connection is established between the monitored device 202 and the monitoring server 204 in block 210. After establishing the connection, status items are transmitted in block 212 from the monitored device 202 and received in block 214 by the monitoring server 204. The server 204 may store the items in a database in block 216.

The connection established in block 210 may be initiated by either the monitored device 202 or the monitoring server 204. In many cases, a default type of connection may be established where either the monitored device 202 or monitoring server 204 may periodically initiate the connection of block 210.

In some cases, the monitored device may initiate communication by default, but the monitoring server 204 may also have the capability to initiate a connection and request status items. Such a case may be where the monitored device 202 is configured to push status items to the server 204 on a periodic basis, but the server 204 may request an immediate status at any time. Such a scenario may occur when the periodic connection is quite long but a client device 206 connected to the server 204 may request a current status.

The database of block 216 may be any type of repository for data. In some embodiments, long histories of data may be accumulated over time for various reports, while in other embodiments, the current status may be tracked and older data discarded. Each embodiment may use different mechanisms for storing and retrieving data.

After data are stored in the database in block 216, a connection is established in block 218 between the server 204 and the client device 206.

The connection established in block 218 may be initiated by either the client 206 or the server 204. Communication initiated by the server 204 may be the result of an alert that is created by the server 204 and sent to the client device 206. Communication initiated by the client device 206 may be an administrator logging onto the server 204 to check a current status. Other scenarios may also be used to initiate communication from either device.

The client device 206 may request status in block 220, which is transmitted in block 222 by the server 204 and received in block 224 by the client 206.

The client device 206 may be any device capable of communicating with the server 204. In some embodiments, a web-based interface may be used, while other embodiments may use different communications mechanisms. In some cases, a gadget or other small application may be used to periodically monitor the status. In some cases, the monitored device 202 may function as the client device 206 as well. For example, a monitored device 202 may have a gadget or other monitoring program that may periodically receive updates of the status of the device 202. A user of the monitored device 202 may use a web browser to interface with the monitoring server 204 to perform the functions of the client device 206.

The client device 206 may send a command in block 226 to the monitoring server 204 that receives the command in block 228. The command may be any form of communication that causes a change of the monitored device 202. The possible commands may include making direct or indirect changes to any monitored function, interfacing and controlling applications or system level parameters, causing operating system level functions to be executed, or any other command.

After receiving a command in block 228, a connection may be established in block 230 between the monitoring server 204 and the monitored device 202. In many cases, the monitoring server 204 may establish the connection in block 230. In some cases, an open communication session may have previously existed and a new communication session may not be established.

The monitoring server 204 may transmit the command in block 232 to the monitored device 202, which may receive the command in block 234 and execute the command in block 236.

The monitored device 202 may execute the command in many different manners. For example, the monitored device 202 may have a set of predetermined scripts that may be run in response to a command. In other cases, the command received in block 234 may be a script that is interpreted and executed. In some cases, the monitored device 202 may have an application that receives the command of block 234 and performs an action in response to the command. Each embodiment may have different mechanisms by which commands may be transmitted, received, and interpreted.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A system comprising:
a status database;
a status collector adapted to:
establish a first connection with a monitored device;
receive status items from said monitored device, each of said status items being related to a system function of said monitored device; and
store said status items in said status database;
an interface for a remote device adapted to:
establish a second connection with a remote device;
send at least one status item to said remote device;
receive at least one command from said remote device for said monitored device;
a command dispatcher adapted to:
establish a third connection with said monitored device; and
transmit a command to said monitored device, said command being related to at least one of said status items.

2. The system of claim 1, said first connection and said third connection being established over the Internet.

3. The system of claim 1, said first connection being a secure connection.

4. The system of claim 1, said first connection being initiated by said system.

5. The system of claim 1, said first connection being initiated by said monitored device.

6. The system of claim 1, said interface for a remote device comprising a secure connection.

7. The system of claim 1, said interface for a remote device comprising a web interface.

8. The system of claim 1, said interface for a remote device comprising a gadget operating on said remote device.

9. The system of claim 1 further comprising:
an alert generator adapted to:
determine that at least one of said status items is outside a predetermined bound; and
send a message to said remote device.

10. A method comprising:
monitoring a plurality of system functions and determining a plurality of status items, at least one of said status items being determined for each of said system functions;
connecting to a centralized server;
transferring said status items to said centralized server;
receiving a command relating to one of said status items from said centralized server; and
performing a function relating to said command, said function being adapted to alter said one of said status items.

11. The method of claim 10, said system functions comprising security functions.

12. The method of claim 11, said security functions comprising:
anti-virus functions;
anti-malware functions;
firewall functions;
content filtering functions;
application installation functions;
encryption functions; and
network connection functions.

13. The method of claim 1, said system functions comprising device status functions.

14. The method of claim 13, said device status functions comprising:
backup functions;
operating system update functions;
application update functions;
hardware performance status functions;
network connectivity status functions;
application content monitoring functions; and
storage system performance functions.

15. The method of claim 10, said connecting to a centralized server comprising establishing a secure connection to said centralized server.

16. The method of claim 10, said connecting to a centralized server being initiated by said centralized server.

17. The method of claim 10 further comprising:
initiating a connection to said centralized server.

18. A computer readable medium comprising computer executable instructions adapted to perform the method of claim 10.

19. A method comprising:
establishing a first connection with a monitored device;
receiving status items from said monitored device, each of said status items being related to a system function of said monitored device;
storing said status items in a status database;
establishing a second connection with a remote device;
sending at least one status item to said remote device;
receiving at least one command from said remote device for said monitored device;
establishing a third connection with said monitored device; and
transmitting a command to said monitored device, said command being related to at least one of said status items.

20. A computer readable medium comprising computer executable instructions adapted to perform the method of claim 19.
